(19) United States
(12) Patent Application Publication
(10) Pub. No.: US 2026/0228930 A1
(43) Pub. Date: Aug. 6, 2026

(54) EDGE DEVICE POSE-GUIDED PORTRAIT GENERATOR

(71) Applicant: Snap Inc., Santa Monica, CA (US)

(72) Inventors: Aleksandr Belskikh, London (GB); Lucas Anton Christoph Deecke, London (GB); Marija Jegorova, London (GB); Dmitrii Smoliakov, London (GB)

(21) Appl. No.: 19/045,422

(22) Filed: Feb. 4, 2025

(51) Int. Cl. G06T 11/00; G06T 5/50; G06T 5/60

(52) U.S. Cl. CPC G06T 11/00; G06T 5/50; G06T 5/60; G06T 2207/20081; G06T 2207/20084; G06T 2207/20132; G06T 2207/30201

(57) ABSTRACT

Examples relate to image generation and processing technologies for transforming digital photographs into stylized portraits using on-device machine learning. A system preprocesses an input image containing a view of a face to generate a pose and face image by combining a cropped view of the face with a visual representation of a body pose. An edge device model processes the pose and face image to generate a portrait having a predetermined portrait style and comprising a stylized depiction of the face along with a posed body portion. The edge device model is trained using distillation techniques to establish relationships between training inputs comprising pose and face images and corresponding training targets comprising portraits having the portrait style. The system enhances the generated portrait to improve correspondence between the face in the input image and the stylized depiction in the portrait through on-device or backend processing.

### TECHNICAL FIELD

The present disclosures relate to image generation and processing technologies and, in some examples, to algorithms and systems to transform selfie images into stylized portraits using on-device machine learning models with pose-guided generation and enhancement techniques.

### BACKGROUND

Image generation technology has evolved to enable the transformation of digital photographs through machine learning models and neural networks. These technologies utilize various computational techniques to analyze, process, and manipulate visual data, particularly in the context of portrait photography. Machine learning models can process input images and generate modified outputs based on trained parameters. The field of image generation models encompasses preprocessing of visual data, neural network architectures for image manipulation, and post-processing enhancement techniques.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a block diagram illustrating a system for on-device pose-guided portrait generation for edge devices, according to some examples.

FIG. 2 is a flow diagram illustrating a method for on-device pose-guided portrait generation for edge devices, according to some examples.

FIG. 3 is a block diagram illustrating preprocessing components of the system of FIG. 1, according to some examples.

FIG. 4 is a block diagram illustrating portrait generation and enhancement components of the system of FIG. 1, according to some examples.

FIG. 5 is a flow diagram illustrating a method for training an edge device model, according to some examples.

FIG. 6 is a block diagram illustrating training inputs generation components of a model training system, according to some examples.

FIG. 7 is a block diagram illustrating training targets generation components of a model training system, according to some examples.

FIG. 8 is a block diagram illustrating a system for processing extended reality (XR) content, according to some examples.

FIG. 9 is a diagrammatic representation of a networked environment in which the present disclosure may be deployed, according to some examples.

FIG. 10 is a diagrammatic representation of a machine in the form of a computer system within which a set of instructions may be executed to cause the machine to perform any one or more of the methodologies discussed herein, according to some examples.

FIG. 11 is a block diagram showing a software architecture within which examples may be implemented.

FIG. 12 illustrates a machine-learning pipeline, according to some examples.

FIG. 13 illustrates training and use of a machine-learning program, according to some examples.

### DETAILED DESCRIPTION

Examples described herein relate to techniques for transforming digital photographs, such as self-portrait photographs (“selfies”), into stylized portraits using on-device machine learning technologies. These examples address technical challenges in implementing image generation capabilities on edge devices like mobile phones while maintaining processing efficiency and image quality.

In some examples, a system processes images through a three-stage pipeline architecture. In a preprocessing stage, the system obtains an input image containing a view of a face and processes it through several steps. The preprocessing components extract a cropped view of the face from the input image and align this cropped face image with a pose template, which provides a visual representation of body positioning, thereby generating a composite of the cropped input image and the pose template referred to herein as a “pose and face image”. The system may also generate embeddings from the cropped image to serve as additional input for the portrait generation process.

During a portrait generation stage, an edge device model processes the preprocessed inputs to generate a stylized portrait. This model runs directly on the user's device and transforms the pose and face image into an artistic or stylized portrait according to a specific portrait style defined during the training of the model. The edge device model is trained by establishing relationships between training inputs comprising pose and face images and corresponding training targets comprising portraits with defined style characteristics.

In some examples, the system includes a postprocessing stage to enhance or refine the generated portrait. The postprocessing stage can operate either directly on the edge device or through backend processing (e.g., on a server or a cloud computing system), depending on implementation requirements. The enhancement process can include improving aesthetic quality and improving the fidelity of the face in the generated portrait to the face in the source input image.

The training process for the edge device model utilizes distillation to train the relatively lightweight edge device model using a large training dataset generated by a larger, more computationally intensive pretrained image generation model. The training data is generated based on a starting set of facial images, which can incorporate synthetic faces (e.g., face images generated using an existing image generation model) and/or real-world facial images. The training process may include quality checks on these input images, including geometric centering verification (e.g., discarding images with face rotated from the vertical (roll), rotated away from the camera (yaw), or looking too far down or up (pitch)) and color data validation (e.g., discarding black and white images). A dataset of training inputs is generated by preprocessing the input images, using preprocessing steps similar to those used by the portrait generation system during inference, as described above. A dataset of corresponding training targets is generated by applying the pretrained image generation model to the input images, along with data inputs that constrain the style of the generated training target, such as text prompts and/or model configuration data. The edge device model is then trained to learn relationships between the dataset of training inputs and the dataset of corresponding training targets, using machine learning training loss generation and propagation techniques.

In various examples, the system can include various additional features. The pose template can be generated or obtained by any suitable technique: for example, it can be randomly selected, user-defined, or context-driven. The portrait enhancement process can occur on-device or through backend services. In some examples, the system can implement full-head enhancement techniques during the postprocessing stage instead of simply face enhancement: thus, for example, a selfie of a user wearing a hat or having a distinct hairstyle could result in a portrait of the user that preserves the hat or the hairstyle in examples using full-head enhancement.

The described techniques address practical constraints of edge device deployment by optimizing the edge device model to run within a reasonable execution time (e.g., one second) on common user devices, such as smart phones, tablets, and/or wearable devices. In some examples, the system can operate without requiring real-time prompt generation. In some examples, processing can be distributed between on-device and backend components as needed. Thus, in some examples, the described examples make image generation capabilities accessible on edge devices while managing computational resources and maintaining aesthetic standards.

In some examples, the training process for the edge device model is repeated multiple times, using different style parameters (e.g., prompt data and/or model configuration data) for each model, to train multiple lightweight edge device models, each such lightweight model being operable in inference mode to generate portraits in a distinctive style. In such examples, the same dataset of training inputs can be generated once and re-used for training each model; the dataset of training targets can be generated from the set of input images by changing the style prompts and/or configuration data when processing the input images to generate the training targets in the desired portrait style. These models can then be deployed as components of individual lightweight software applications in an app store or a similar repository. A user who wants to generate portraits in a specific style can select the application with the appropriate model, download the application (including the trained edge device model) onto the user's edge device, and then use the application to generate portraits in the app-specific style, on-device, as desired.

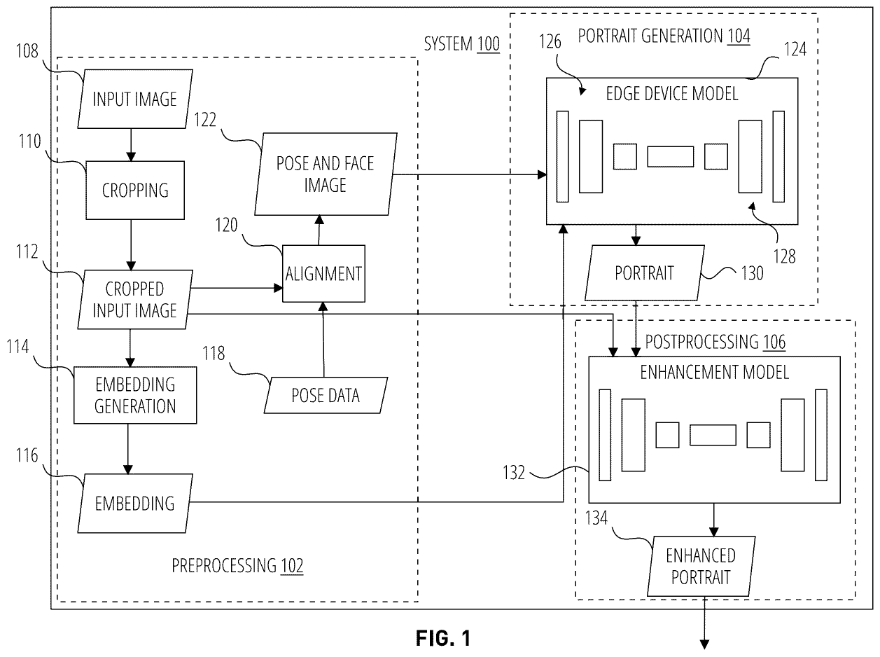

FIG. 1 is a block diagram illustrating a system 100 for on-device pose-guided portrait generation for edge devices.

Functional blocks of the system 100 shown in FIG. 1 may be referred to herein by their function (e.g., “cropping 110”), or as a “component”, “module”, “operation”, “process”, “block”, “functional block”, or similar such terminology. Example implementations of each such functional block are described herein, but it will be appreciated by the skilled person that other implementations for these various functional blocks can be substituted in some examples.

The system 100 includes three stages: preprocessing 102, portrait generation 104, and postprocessing 106. The preprocessing 102 stage receives an input image 108 containing a view of a face. The input image 108 is processed by a cropping 110 component to generate a cropped input image 112.

In some examples, the cropped input image 112 is provided to an embedding generation 114 component, which generates embeddings 116 of the cropped input image 112 according to existing machine learning techniques. In machine learning, embeddings are numerical representations of input data that capture meaningful features and relationships in a format that can be processed by neural networks. In the context of this system 100, the embeddings 116 are optional conditional information extracted from the cropped input image 112 during preprocessing 102 that provide additional input features to guide the edge device model 124 in generating the stylized portrait output while maintaining identity characteristics.

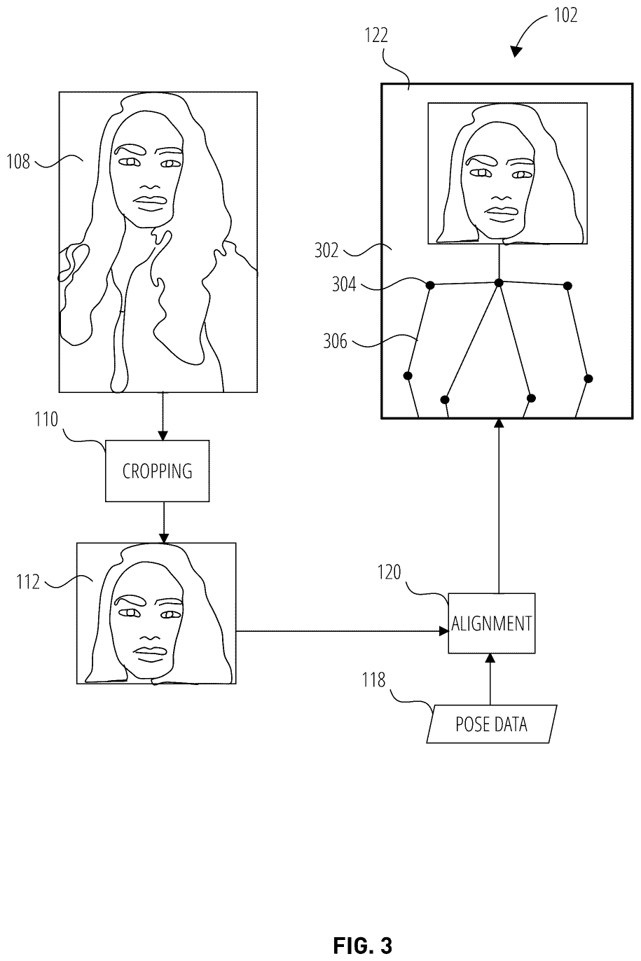

The preprocessing 102 stage can also include an alignment 120 component that receives pose data 118 and the cropped input image 112. The alignment 120 component combines these inputs to generate a pose and face image 122 that includes both the view of the face and a visual representation of at least a portion of a body pose. In some examples, the alignment 120 component performs pose template alignment using facial landmarks to size, rotate, and/or translate the face to align the face with a pose template. As described above, the pose data 118 can be generated or obtained from any of a number of sources or techniques, such as random generation, a pre-existing set of poses used in previous training of the edge device model 124, user input, or any other suitable source. Because pose data is relatively sparse—e.g., a head-and-shoulders portrait may only require 5 to 10 key points represented as constrained coordinate sets (x, y, z) corresponding to joints or other key location of a body, such as shoulders, elbows, and collarbone-the generation of pose data is usually a computationally lightweight task. The alignment 120 component generates a simple image of the pose, for example as a black background with different-colored segments connecting the key points- and superimposes and aligns the cropped input image 112 to the proper location and orientation within the pose image. A more detailed example of preprocessing 102 is described below with reference to FIG. 3.

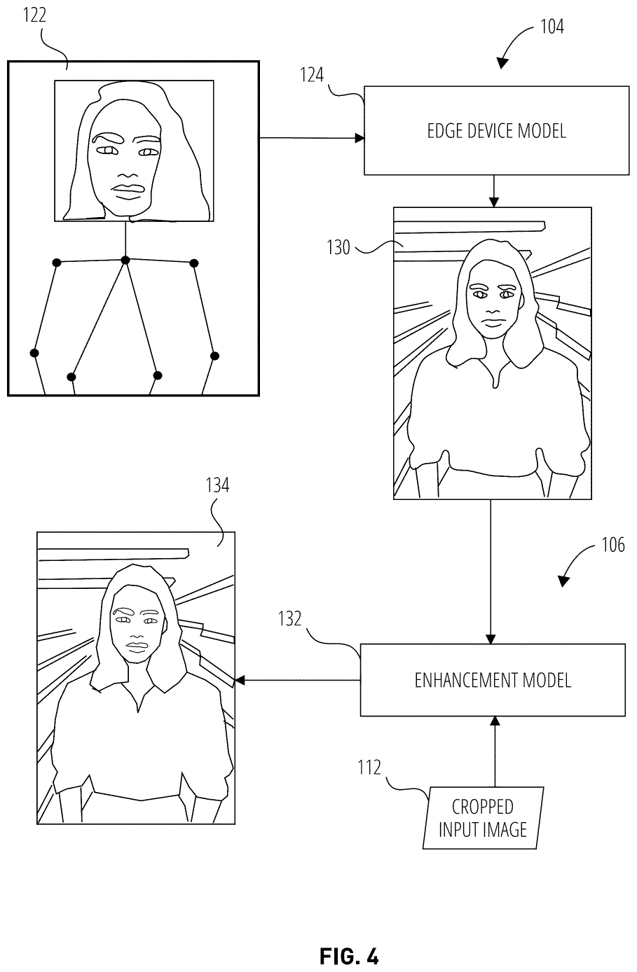

The portrait generation 104 stage includes an edge device model 124 that processes the pose and face image 122, and optionally the embeddings 116, to generate a portrait 130. The edge device model 124 generates the portrait 130 having a predetermined portrait style defined by the training of the edge device model 124. The portrait 130 includes a stylized depiction of the face from the input image 108, along with at least a portion of a body posed according to the input pose data 118. A more detailed example of portrait generation 104 is described below with reference to FIG. 4.

The postprocessing 106 stage includes a pretrained enhancement model 132 that receives both the portrait 130 and the cropped input image 112 as inputs. The enhancement model 132 processes these inputs to generate an enhanced portrait 134, focusing on improving correspondence between the face in the input image 108 and the stylized depiction of the face in the portrait. In some examples, when the input image 108 comprises a view of a head that includes the view of the face, the enhancement processing enhances correspondence between the view of the head in the input image and a stylized depiction of the head in the portrait. In some examples, the enhancement model 132 may be a large (e.g., a large number of parameters relative to the edge device model 124) pretrained image generation model trained to receive two input images and generate an output image in which the face (or entire head) from a first input image is modified to more closely resemble the face (or entire head) from the second input image. The enhancement model 132 may therefore be referred to herein as a “face swap” or “head swap” model. A more detailed example of postprocessing 106 is described below with reference to FIG. 4.

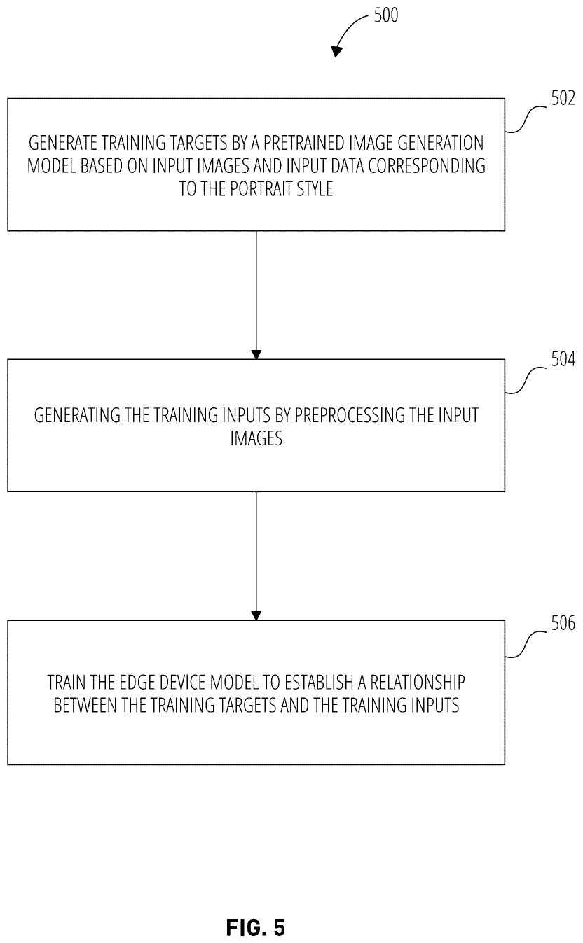

The edge device model 124 operates directly on an edge device, such as a mobile device, and is trained using knowledge distillation to establish relationships between training inputs comprising pose and face images and corresponding training targets comprising portraits with specific style characteristics. The training of the edge device model 124 is described in greater detail below with reference to FIG. 5 through FIG. 8. In some examples, the edge device model 124 is trained on datasets generated by a pipeline of operations that include one or more pretrained image generation models prompted by style parameters (e.g., prompts and/or model configuration data) to generate portraits in the specified style as well as corresponding pose and face images. Thus, the edge device model 124 can be trained by distilling the knowledge of the entire pipeline used to generate the training datasets, which may include a relatively large number (e.g., on the order of 25,000 or 100,000) pairs of corresponding training inputs (e.g., pose and face images) and training targets (e.g., stylized portraits).

In some examples, the edge device model 124 is implemented as a UNet or other suitable image generation model architecture that is constrained to have a limited parameter count, enabling execution within one second on common mobile devices. The edge device model 124 processes pose and face images through image encoder 126 and image decoder 128 components to generate stylized portraits from images provided as input (e.g., pose and face images 122). In some examples, the model architecture is optimized through distillation techniques using on the order of tens of thousands of training pairs to establish relationships between preprocessed inputs and stylized portrait outputs while maintaining computational efficiency for edge device deployment, as described in greater detail below.

The enhancement postprocessing 106 performed by the enhancement model 132 may be performed directly on the edge device, or alternatively, may be performed at least in part by components of the system 100 separate from the edge device through calls to backend services.

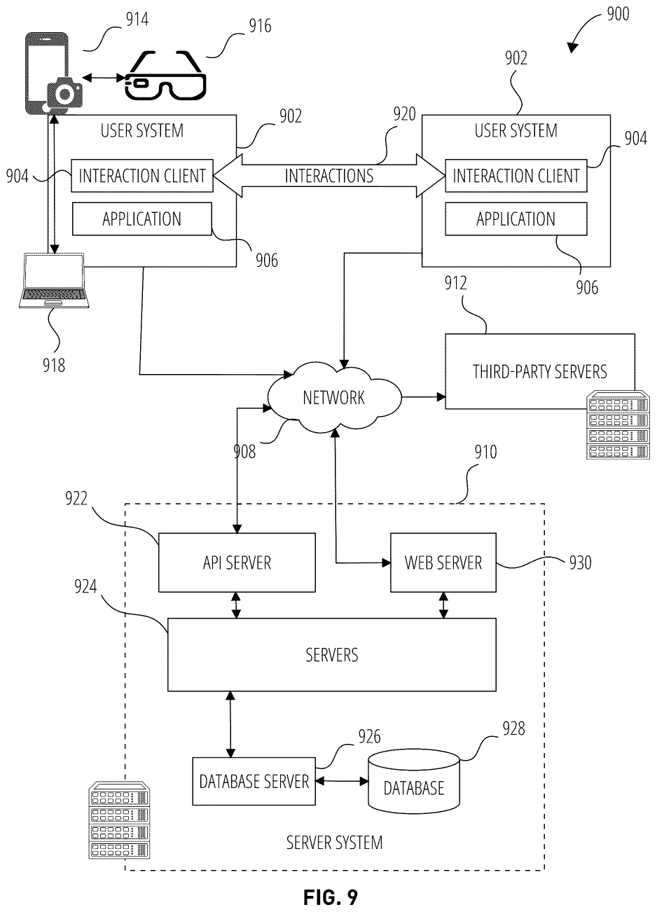

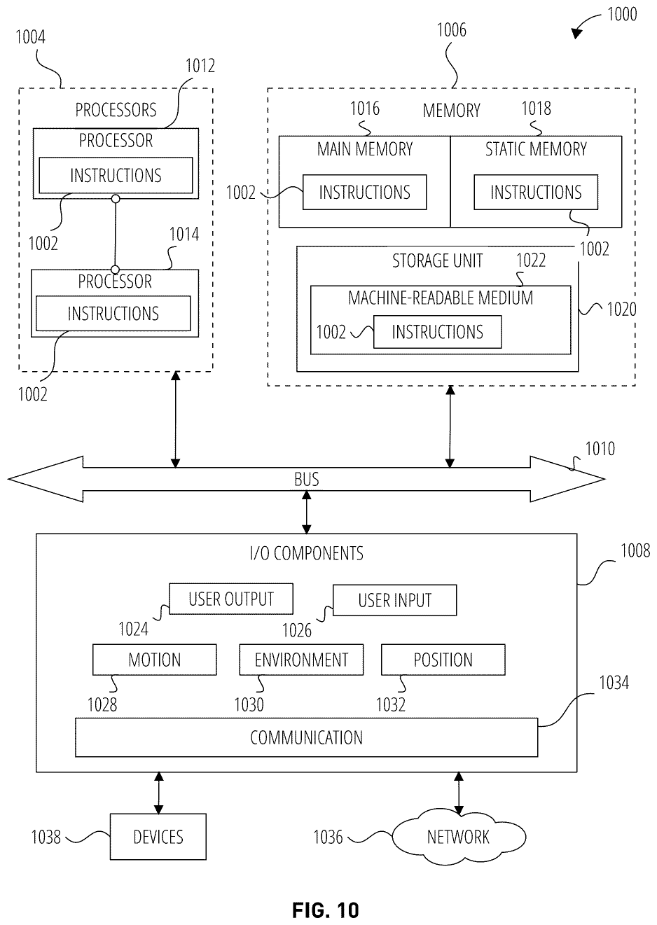

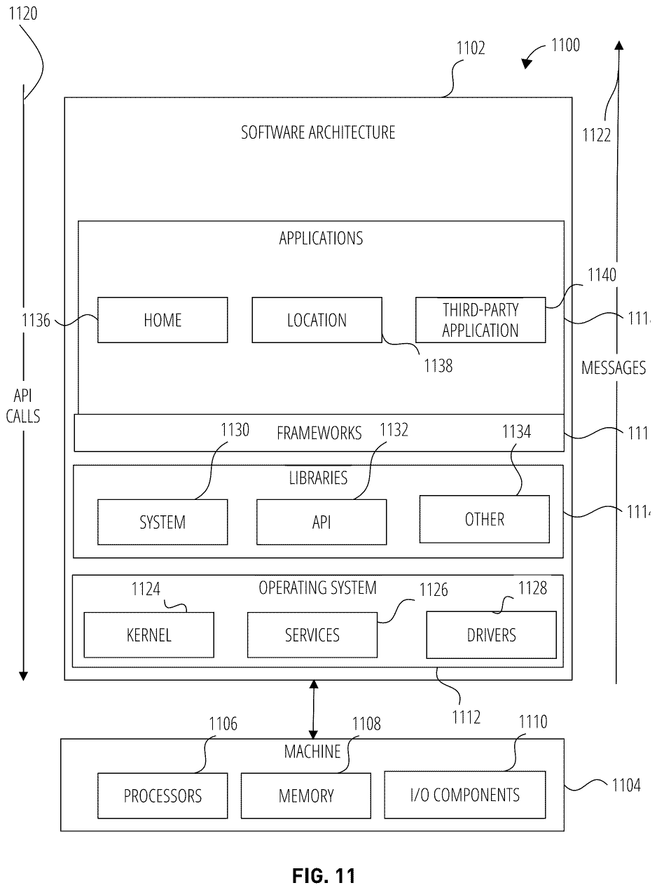

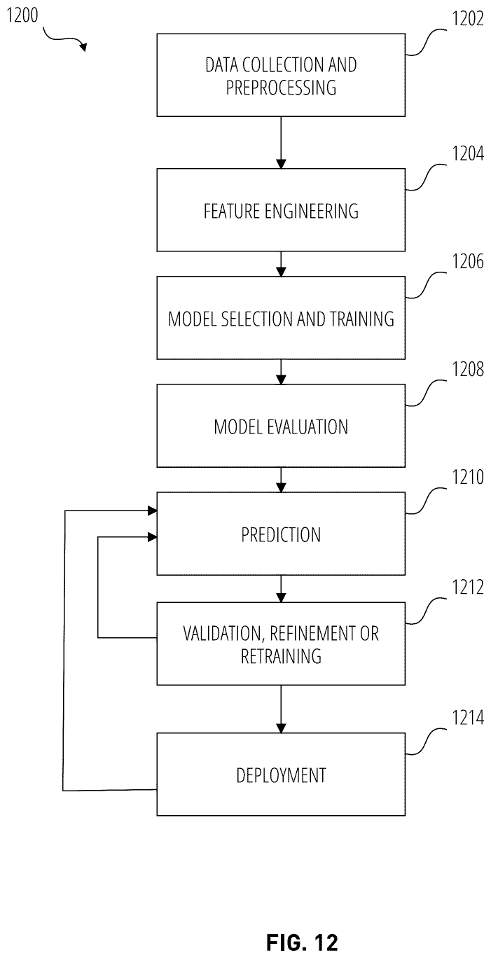

Examples of edge devices and other system components communicating with the edge device over a network are described below with reference to FIG. 9 (showing a networked computing environment that can include edge devices and other components such as servers or other backends), FIG. 10 (showing an example machine architecture suitable for implementing edge devices, servers, or other computing devices), and FIG. 11 (showing an example software architecture suitable for implementing the software components of the system 100, of edge devices, and/or other local or distributed computing components such as backend servers). FIG. 11 and FIG. 12 provide examples of machine learning techniques that can be used to implement the training and inference of the edge device model 124, the enhancement model 132, the models used in the pipeline to generate the distillation training data, and/or other machine learning models and operations described herein.

Thus, in some examples, the system 100 enables transformation of standard selfie photographs into stylized portraits that adhere to a predefined style, while maintaining processing efficiency through its multi-stage pipeline architecture and its lightweight edge device model 124. The preprocessing 102 prepares normalized inputs, the portrait generation 104 performs the core stylistic transformation, and the postprocessing 106 refines the output (either on-or off-device) to ensure aesthetic quality and recognizable facial characteristics.

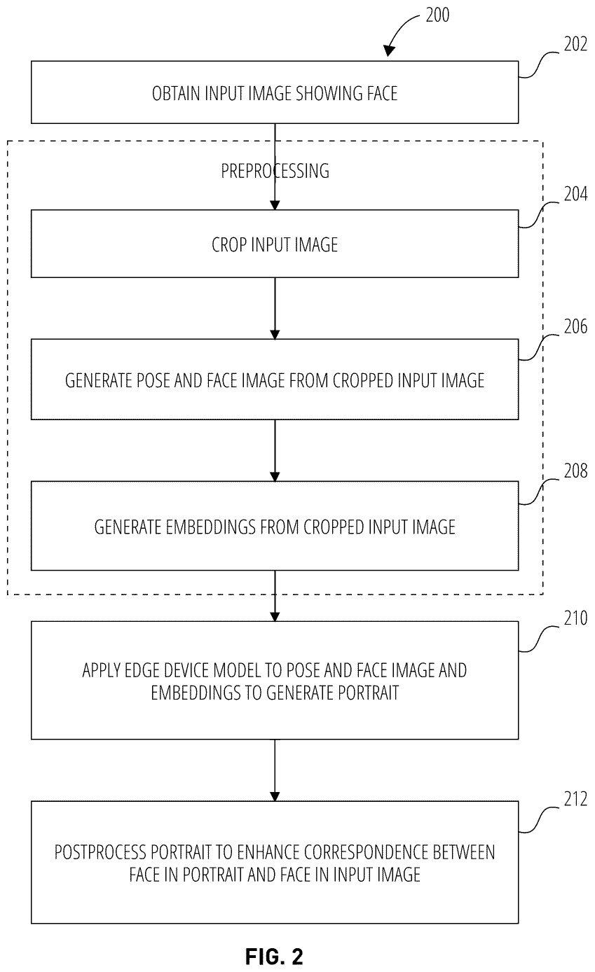

FIG. 2 is a flow diagram illustrating a method 200 for on-device pose-guided portrait generation for edge devices.

Whereas example operations of the method 200 are described with reference to the system 100 of FIG. 1, it will be appreciated that some examples of the method 200 can be performed using other suitable means.

Although the example method 200 depicts a particular sequence of operations, the sequence may be altered without departing from the scope of the present disclosure. For example, some of the operations depicted may be performed in parallel or in a different sequence that does not materially affect the function of the method 200. In other examples, different components of an example device or system that implements the method 200 may perform functions at substantially the same time or in a specific sequence.

The method 200 begins with obtaining an input image 108 showing a face at operation 202. In some examples, the input image 108 comprises a self-portrait photograph captured via at least one optical sensor of a mobile device, such as a camera of a mobile device.

The next three operations of the method 200 (operation 204, operation 206, and operation 208) are performed during the preprocessing 102 stage. The input image 108 is cropped at operation 204. The cropping operation 204 includes cropping the input image 108 to generate a cropped input image 112 containing the view of the face. In some examples, the cropping operation 204 also includes quality control of the input image 108 to ensure high-quality portrait output For example, the cropping operation 204 can discard or reject input images 108 based on criteria including improper rotation of the face (e.g., tilting of the head too far to the left or right, or excessive rotation of the camera relative to the face), an improper view of the face (e.g., the face turned too far away from the camera to show a full or three-quarters profile view instead of a head-on full-face frontal view), or improper color data (e.g., insufficient brightness or contrast to discern the face, or a black and white photograph when generating a color portrait). During inference (e.g., method 200 performed by the user's edge device), a rejected or discarded input image 108 can result in an error message being displayed to the user. However, in some examples, the preprocessing 102 operations are also used for training dataset generation as described below with reference to FIG. 5 to FIG. 8. In the training context, discarding or rejecting an input image 108 may result in the improper input image being omitted from the data used to generate the distillation training data.

At operation 206, the method 200 generates a pose and face image 122 from the cropped input image 112 by combining the cropped face view with a visual representation of at least a portion of a body pose. The alignment 120 component receives both the cropped input image 112 and pose data 118 as inputs. The pose data 118 comprises a sparse set of key points represented as constrained coordinate sets corresponding to joints or other key locations of a body, such as shoulders, elbows, and collarbone. Depending on the intended style, the pose data 118 may also include other key points, such as a posed full body. The alignment 120 component generates a simple image of the pose, for example as a black background with different-colored segments connecting the key points, and superimposes and aligns the cropped input image 112 to the proper location and orientation within the pose image. The pose template used in this operation may be randomly selected, user-defined, or determined based on context. The resulting pose and face image 122 includes both the aligned view of the face and the visual representation of the body pose, which serves as input for the subsequent portrait generation 104 stage.

Operation 208 generates embeddings 116 from the cropped input image. The embeddings 116 comprise numerical representations extracted as conditional information to help guide the portrait generation 104 process. This operation 208 is optional, as the system 100 may function without embedding generation 114.

At operation 210, the method 200 applies the edge device model 124 to the pose and face image 122, and optionally the embeddings 116, to generate a portrait 130. The edge device model 124 operates directly on an edge device, such as a mobile device, and transforms the pose and face image 122 into an artistic portrait 130 according to a specific style. The edge device model 124 generates the portrait 130 having a predetermined portrait style defined by the training of the model, comprising a stylized depiction of the face along with at least a portion of a body posed according to the input pose data 118.

At operation 212, the method 200 performs postprocessing 106 to enhance correspondence between the face in the portrait 130 and the face in the input image 108. The enhancement model 132 receives both the portrait 130 and the cropped input image 112 (or another suitable version of the input image 108) as inputs to generate an enhanced portrait 134. In some examples, when the input image 108 comprises a view of a head that includes the view of the face, the enhancement processing enhances correspondence between the view of the head in the input image 108 and a stylized depiction of the head in the portrait 130. The enhancement postprocessing 106 may be performed directly on the edge device, or alternatively, may be performed at least in part by components of the system separate from the edge device through calls to backend services. For example, if inference using the enhancement model 132 is computationally intensive, the enhancement model 132 may be applied in a backend environment such as one or more servers.

FIG. 3 is a block diagram illustrating example preprocessing 102 components of the system 100.

The preprocessing 102 stage receives an input image 108 containing a view of a face. As shown, the input image 108 is a selfie showing a woman's face, head, and shoulders, with her left arm extended to hold her mobile device to take the photograph.

The input image 108 is processed by a cropping 110 component to generate a cropped input image 112. In some examples, as described above, the cropping 110 component performs quality control operations on the input image 108, applying such criteria as improper rotation of the face, improper view of the face, and/or improper color data. As shown, the cropped input image 112 shows a portion of the input image 108 containing only the woman's head and showing her face.

The cropped input image 112 is provided to the alignment 120 component. The alignment 120 component receives both the cropped input image 112 and pose data 118 as inputs. The alignment 120 component generates a pose and face image 122 by combining the cropped input image 112 with a visual representation of at least a portion of a body pose. The alignment 120 component generates a simple image of the pose, for example as a black background with different-colored segments connecting the key points, and superimposes and aligns the cropped input image 112 to the proper location and orientation within the pose image. As shown, the pose and face image 122 shows the cropped input image 112 superimposed on a black background 302 with key points 304 (e.g., shown as white or colored circles) connected by segments 306 (e.g., shown as lines, each having a distinct color). In the illustrated example, the key points 304 shown in the pose and face image 122 include two shoulders, a collarbone/throat, two elbows, and two hips. The depicted pose is roughly from the waist up, with arms slightly bent at the sides. Notably, the pose shown in the pose and face image 122 differs from the pose in the input image 108. The pose of the pose and face image 122 is used to guide the generation of the portrait 130 to have a similar pose. For this reason, the generation or selection of the pose data 118 can be constrained to match a pose, set of similar poses, or constrained range of poses used during training of the edge device model 124 to generate the distillation training dataset, such that the edge device model 124 is trained to generate portrait 130 showing poses within this constrained domain.

The preprocessing 102 components interface with subsequent stages of the system 100 by providing the pose and face image 122 as input to the edge device model 124 in the portrait generation 104 stage. The pose and face image 122 serves as the primary input for generating a stylized portrait 130 according to the trained parameters of the edge device model 124. Although not shown in FIG. 3, some examples also generate embeddings 116 and provide the generated embeddings 116 as a further input to the portrait generation 104 stage, as described above.

FIG. 4 is a block diagram illustrating portrait generation 104 and enhancement postprocessing 106 components of the system 100.

The portrait generation 104 stage receives a pose and face image 122 as input, shown as the pose and face image 122 of FIG. 3. The edge device model 124 processes the pose and face image 122 to generate a portrait 130. The edge device model 124 generates the portrait 130 having a predetermined portrait style defined by the training of the model. As shown, the portrait 130 depicts a woman having a face similar to the woman's face in the input image 108, cropped input image 112, and pose and face image 122 of FIG. 3. Notably, the face in the portrait 130 is generated by the edge device model 124 as a portion of the overall portrait 130. The portrait 130 depicts the woman in a pose matching the pose shown in the pose and face image 122: from the waist or hips up, with arms slightly bent at her sides. The other stylistic elements of the portrait 130 are the result of the style parameters used to train the edge device model 124: the artistic style, the lighting, the woman's clothes, and the background may all be depicted in the portrait 130 to match the portrait style on which the edge device model 124 was trained.

Thus, the portrait 130 includes a stylized depiction of the face from the source selfie, along with at least a portion of a body posed according to the input pose data. In some examples, the portrait 130 includes background elements and aesthetic characteristics defined during the training of the edge device model 124.

In some examples, the embeddings 116 generated at the preprocessing 102 stage (not shown) are also used by the edge device model 124 to further guide generation of the portrait 130, and specifically to guide generation of the face in the portrait 130 based on numerical image embeddings (e.g., multidimensional vectors in a space defining image characteristics) of the cropped input image 112.

In the postprocessing 106 stage, the enhancement model 132 receives both the portrait 130 and the cropped input image 112 as inputs. In some examples, another source for the input face is used instead of the cropped input image 112, such as the input image 108 or pose and face image 122. In some examples, the embeddings 116 generated at the preprocessing 102 stage (not shown) are also used by the enhancement model 132 as a further input. The enhancement model 132 processes these inputs to generate an enhanced portrait 134. As shown, the enhanced portrait 134 depicts the same posed body and background as the portrait 130, in the same artistic style and with the same aesthetic and lighting properties as the portrait 130, but with the face modified to more closely match the facial characteristics of the face shown in the input image 108. Thus, the enhancement postprocessing 106 focuses on improving correspondence between the face in the input image 108 and the stylized depiction of the face in the enhanced portrait 134.

In some examples, when the input image 108 comprises a view of a head that includes the view of the face, the enhancement model 132 enhances correspondence between the view of the entire head in the input image and a stylized depiction of the entire head in the portrait. For example, the user's hair, head covering, ears, earrings, or others head features in the input image 108 can be preserved in the enhanced portrait 134 when using a head swap model instead of a face swap model for the enhancement model 132.

The enhancement postprocessing 106 performed by the enhancement model 132 may be executed directly on the edge device, or alternatively, may be performed at least in part by components of the system separate from the edge device through calls to backend services. The choice between on-device or backend processing may depend on the computational requirements of the enhancement model 132.

FIG. 5 is a flow diagram illustrating a method 500 for training an edge device model.

Whereas example operations of the method 500 are described with reference to the system 100 of FIG. 1, it will be appreciated that some examples of the method 500 can be performed using other suitable means.

Although the example method 500 depicts a particular sequence of operations, the sequence may be altered without departing from the scope of the present disclosure. For example, some of the operations depicted may be performed in parallel or in a different sequence that does not materially affect the function of the method 500. In other examples, different components of an example device or system that implements the method 500 may perform functions at substantially the same time or in a specific sequence.

The method 500 includes three primary operations for training the edge device model 124. At operation 502, the method 500 generates a training targets dataset consisting of a large set (e.g., tens of thousands) of training targets. Each training target is generated using a pretrained image generation model based on two inputs: an input image, and input data specifying the portrait style. The input data can include prompt data (e.g., a text prompt and/or an image prompt) and/or configuration data (e.g., configuration parameters for the model) that constrain the style characteristics of the generated training targets.

The pretrained image generation model generates the training targets using the prompts and/or configuration data, which are fixed over the training process. In some examples, the fixed prompt used as input to the model during training specify style characteristics, which can include visual style and background information (e.g., “{man/woman}, 1980s style, film grain, vintage photo, 90s, jeans jacket, messy 80s curly hair, warm color tint, navy shirt, new york street, gray light, fog, volumetric fog, motion blur, bokeh, 80 mm f/2.8 , 1/50s, ISO 400”). The configuration data can correspond to settings for the image generation pipeline for a particular stylistic theme or template.

The pretrained image generation model can be supplemented by other pre-and/or post-processing operations, which can include processing by other pretrained models, to form an image generation pipeline. The training targets are the output of the image generation pipeline, which may be significantly more computationally intensive than the edge device model 124, because the training target generation pipeline does not have to execute in real time and can be executed on a large backend computing system, such as a server array.

Operation 502 is repeated for each input image in the source dataset (e.g., tens of thousands of times).

At operation 504, the method generates training inputs by preprocessing the input images. The preprocessing of operation 504 applies operations similar to those used in the preprocessing 102 stage during inference, including cropping input images to generate cropped images containing views of faces, and generating pose and face images by combining the cropped images with visual representations of body poses. As in the preprocessing 102 stage used during inference, some examples may also generate embeddings from the cropped input image.

Operation 504 is also repeated for each input image in the source dataset (e.g., tens of thousands of times).

The input images used to generate the training inputs dataset and the training targets dataset can be drawn from a large source dataset (e.g., one input image per training input and corresponding training target) that can include synthetic faces and/or real-world facial images (e.g., facial images from licensed datasets), as described above.

At operation 506, the method 200 trains the edge device model 124 to establish relationships between the training targets and the training inputs. The training process utilizes distillation techniques to train the edge device model 124 using the training inputs dataset and training targets dataset (e.g., approximately 25,000 to 100,000 pairs of corresponding training inputs and training targets). During training, the edge device model 124 is provided with input in the form of a training input (optionally supplemented by embeddings generated at operation 504), and the model output is compared to the corresponding training target to generate one or more losses, which are used to adjust the model parameters. Over the course of one or more training epochs in which the entire training inputs dataset and training targets dataset are processed by the edge device model 124, the edge device model 124 becomes trained by distilling the relationship between the inputs and targets as generated by operation 502 and operation 504.

In some examples, multiple edge device models 124 is trained to generate a set of style-specific lightweight models. The training process may be repeated multiple times with different style parameters to train multiple lightweight edge device models 124, each trained to generate portraits in a distinctive style. These models may then be deployed as components of individual lightweight software applications, e.g., in an app store.

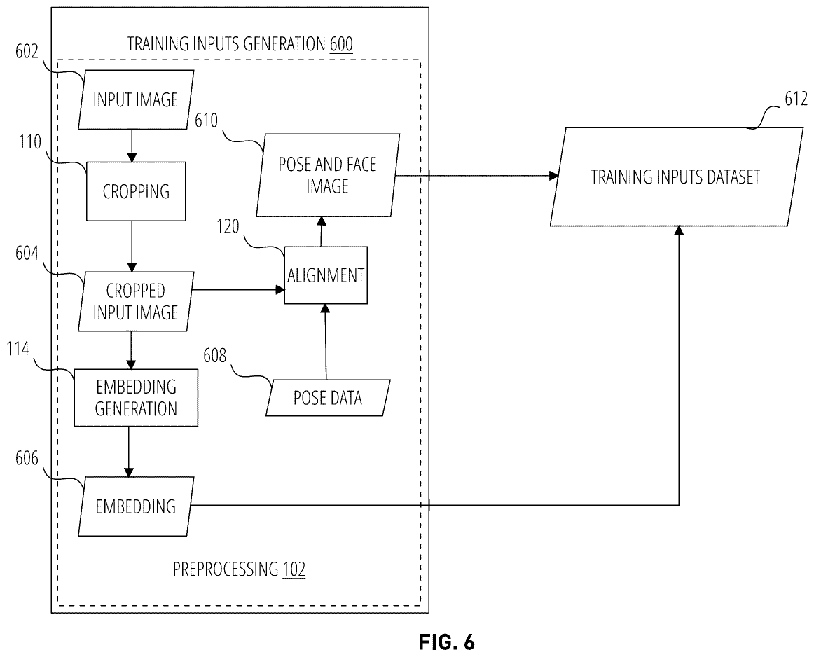

FIG. 6 is a block diagram illustrating a training inputs generation 600 stage of a model training system. The training inputs generation 600 stage performs operation 502 of method 500 to generate the training inputs dataset 612.

In the illustrated example, the training inputs generation 600 operates identically to the preprocessing 102 stage of the system 100, and may use the same components in some examples: input images 602 are copped by the cropping 110 component to generate cropped input images 604, from which the embedding generation 114 component optionally generates embeddings 606. The cropped input images 604 and pose data 608 are used as input to the alignment 120 component to generate the pose and face images 610.

Each generated pose and face image 610, optionally with its corresponding embeddings 606, is stored in a training inputs dataset 612 as an individual training input. The training inputs generation 600 stage can operate on each input image from the source dataset to generate the entire training inputs dataset 612 of, e.g., tens of thousands of training inputs.

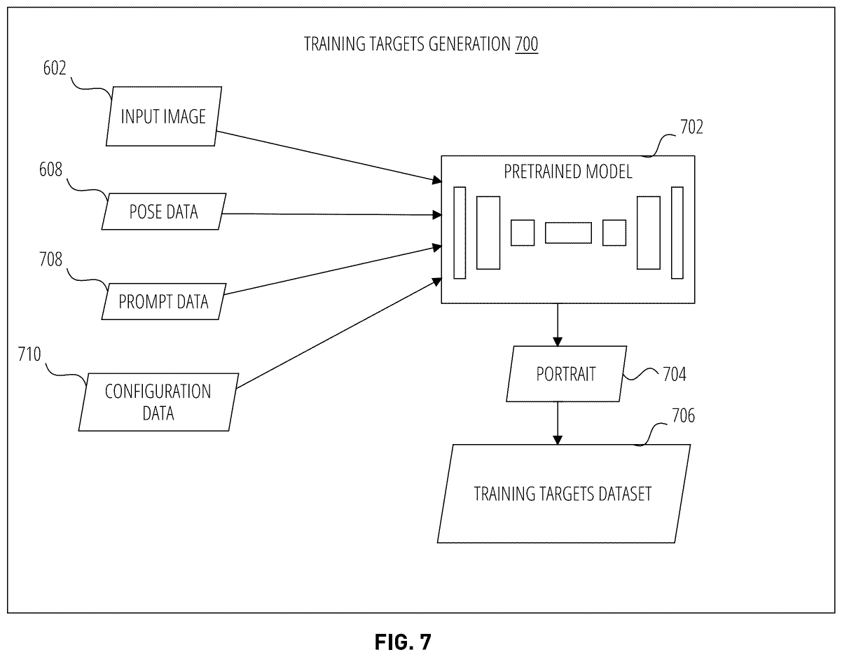

FIG. 7 is a block diagram illustrating a training targets generation 700 stage of a model training system. The training targets generation 700 stage performs operation 504 of method 500 to generate the training targets dataset 706.

An image generation pipeline, shown as a single pretrained model 702 (but which can include multiple models and/or other components, as described above), receives multiple inputs: the same input image 602 as the training inputs generation 600 of FIG. 6, the same pose data 608 as the training inputs generation 600 of FIG. 6, prompt data 708 for defining the portrait style (as described above), and configuration data 710 for defining the portrait style (as described above). The pretrained model 702 processes these inputs to generate a portrait 704 in the specified style, based on the face in the input image 602.

Each portrait 704 is stored in the training targets dataset 706 as an individual training target corresponding to the training input in the training inputs dataset 612 of FIG. 6 generated based on the same input image 602. The training targets generation 700 stage can operate on each input image from the source dataset to generate the entire training targets dataset 706 of, e.g., tens of thousands of training targets.

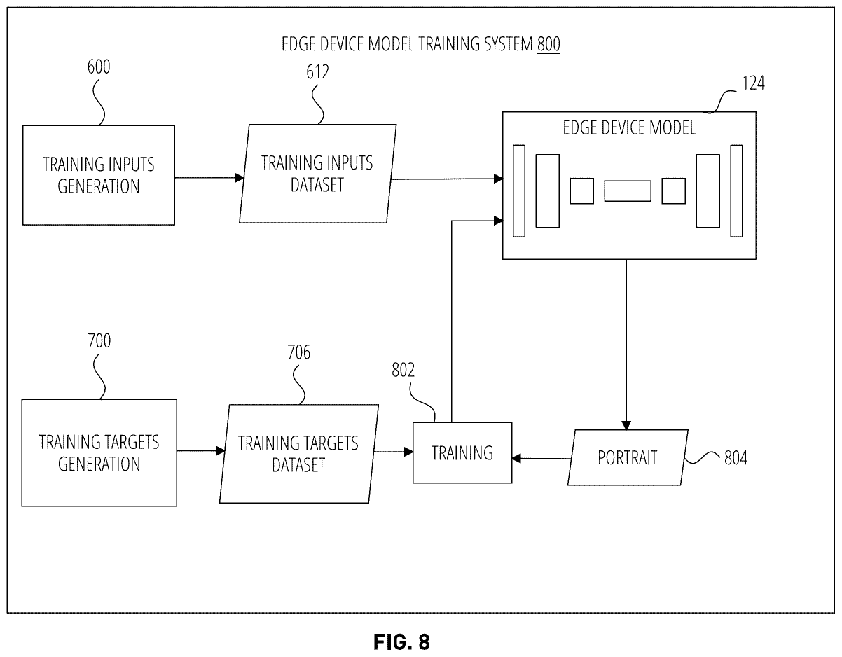

FIG. 8 is a block diagram illustrating an edge device model training system 800. The edge device model training system 800 performs operation 506 of method 500 to train the edge device model 124 using the training inputs dataset 612 and the training targets dataset 706.

The edge device model training system 800 comprises multiple interconnected components that work together to train an edge device model 124 using distillation techniques. The edge device model training system 800 includes the training inputs generation 600 stage to generate the training inputs dataset 612, and the training targets generation 700 stage to generate the training targets dataset 706.

The corresponding pairs of (training input, training target) from the training inputs dataset 612 and training targets dataset 706, respectively, are used to train the edge device model 124 to learn the relationships between the input and the target of each pair. The edge device model 124 processes the training input to generate a portrait 804. The portrait is compared to the corresponding training target by a training 802 component, which generates one or more losses, which are propagated through the layers or components of the edge device model 124 to adjust its parameter values or perform other learning adjustments. In some examples, the training 802 component can employ a mixture of L1/L2, perceptual, and discriminator-based losses to establish relationships between the training inputs and training targets. In some examples, the entire training inputs dataset 612 and training targets dataset 706 are used to train the edge device model 124 for a single epoch, and multiple epochs may be iterated to fully train the edge device model 124.

As described above, the edge device model training system 800 can be used to train multiple different edge device models 124. The same training inputs dataset 612 can be used for training each model; however, a new training targets dataset 706 must be generated for each new model to be trained, with a different set of style parameters (e.g., prompt data 708 and/or configuration data 710) used to generate the training targets at the training targets generation 700 stage.

### Networked Computing Environment

FIG. 9 is a block diagram showing an example digital interaction system 900 for facilitating interactions and engagements (e.g., exchanging text messages, conducting text audio and video calls, or playing games) over a network. The digital interaction system 900 includes multiple user systems 902, each of which hosts multiple applications, including an interaction client 904 and other applications 906. Each interaction client 904 is communicatively coupled, via one or more networks including a Network 908 (e.g., the Internet), to other instances of the interaction client 904 (e.g., hosted on respective other user systems 902), a server system 910 and third-party servers 912). An interaction client 904 can also communicate with locally hosted applications 906 using Applications Program Interfaces (APIs).

Each user system 902 may include multiple user devices, such as a mobile device 914, head-wearable apparatus 916, and a computer client device 918 that are communicatively connected to exchange data and messages.

An interaction client 904 interacts with other interaction clients 904 and with the server system 910 via the Network 908. The data exchanged between the interaction clients 904 (e.g., interactions 920) and between the interaction clients 904 and the server system 910 includes functions (e.g., commands to invoke functions) and payload data (e.g., text, audio, video, or other multimedia data).

The server system 910 provides server-side functionality via the Network 908 to the interaction clients 904. While certain functions of the digital interaction system 900 are described herein as being performed by either an interaction client 904 or by the server system 910, the location of certain functionality either within the interaction client 904 or the server system 910 may be a design choice. For example, it may be technically preferable to initially deploy particular technology and functionality within the server system 910 but to later migrate this technology and functionality to the interaction client 904 where a user system 902 has sufficient processing capacity.

The server system 910 supports various services and operations that are provided to the interaction clients 904. Such operations include transmitting data to, receiving data from, and processing data generated by the interaction clients 904. This data may include message content, client device information, geolocation information, digital effects (e.g., media augmentation and overlays), message content persistence conditions, entity relationship information, and live event information. Data exchanges within the digital interaction system 900 are invoked and controlled through functions available via user interfaces (UIs) of the interaction clients 904.

Turning now specifically to the server system 910, an Application Program Interface (API) server 922 is coupled to and provides programmatic interfaces to servers 924, making the functions of the servers 924 accessible to interaction clients 904, other applications 906 and third-party server 912. The servers 924 are communicatively coupled to a database server 926, facilitating access to a database 928 that stores data associated with interactions processed by the servers 924. Similarly, a web server 930 is coupled to the servers 924 and provides web-based interfaces to the servers 924. To this end, the web server 930 processes incoming network requests over the Hypertext Transfer Protocol (HTTP) and several other related protocols.

The Application Program Interface (API) server 922 receives and transmits interaction data (e.g., commands and message payloads) between the servers 924 and the user systems 902 (and, for example, interaction clients 904 and other application 906) and the third-party server 912. Specifically, the Application Program Interface (API) server 922 provides a set of interfaces (e.g., routines and protocols) that can be called or queried by the interaction client 904 and other applications 906 to invoke functionality of the servers 924. The Application Program Interface (API) server 922 exposes various functions supported by the servers 924.

### External Resources and Linked Applications

The interaction client 904 provides a user interface that allows users to access features and functions of an external resource, such as a linked application 906, an applet, or a microservice. This external resource may be provided by a third party or by the creator of the interaction client 904.

The external resource may be a full-scale application installed on the user's system 902, or a smaller, lightweight version of the application, such as an applet or a microservice, hosted either on the user's system or remotely, such as on third-party servers 912 or in the cloud. These smaller versions, which include a subset of the full application's features, may be implemented using a markup-language document and may also incorporate a scripting language and a style sheet.

When a user selects an option to launch or access the external resource, the interaction client 904 determines whether the resource is web-based or a locally installed application. Locally installed applications can be launched independently of the interaction client 904, while applets and microservices can be launched or accessed via the interaction client 904.

If the external resource is a locally installed application, the interaction client 904 instructs the user's system to launch the resource by executing locally stored code. If the resource is web-based, the interaction client 904 communicates with third-party servers to obtain a markup-language document corresponding to the selected resource, which it then processes to present the resource within its user interface.

The interaction client 904 can also notify users of activity in one or more external resources. For instance, it can provide notifications relating to the use of an external resource by one or more members of a user group. Users can be invited to join an active external resource or to launch a recently used but currently inactive resource.

The interaction client 904 can present a list of available external resources to a user, allowing them to launch or access a given resource. This list can be presented in a context-sensitive menu, with icons representing different applications, applets, or microservices varying based on how the menu is launched by the user.

### Machine Architecture

FIG. 10 is a diagrammatic representation of a machine 1000 within which instructions 1002 (e.g., software, a program, an application, an applet, an app, or other executable code) for causing the machine 1000 to perform any one or more of the methodologies discussed herein may be executed. For example, the instructions 1002 may implement all or part of the functionality of the system 100 and cause the machine 1000 to execute any one or more of the methods described herein, such as method 200. The instructions 1002 transform the general, non-programmed machine 1000 into a particular machine 1000 programmed to carry out the described and illustrated functions in the manner described. The machine 1000 may operate as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch, a pair of augmented reality glasses), a smart home device (e.g., a smart appliance), other smart devices, a web appliance, a network router, a network switch, a network bridge, or any machine capable of executing the instructions 1002, sequentially or otherwise, that specify actions to be taken by the machine 1000. Further, while a single machine 1000 is illustrated, the term “machine” shall also be taken to include a collection of machines that individually or jointly execute the instructions 1002 to perform any one or more of the methodologies discussed herein. In some examples, the machine 1000 may comprise both client and server systems, with certain operations of a particular method or algorithm being performed on the server-side and with certain operations of the particular method or algorithm being performed on the client-side.

The machine 1000 may include processors 1004, memory 1006, and input/output I/O components 1008, which may be configured to communicate with each other via a bus 1010. In an example, the processors 1004 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1012 and a processor 1014 that execute the instructions 1002. The term “processor” is intended to include multi-core processors that may comprise two or more independent processors (sometimes referred to as “cores”) that may execute instructions contemporaneously. Although FIG. 10 shows multiple processors 1004, the machine 1000 may include a single processor with a single-core, a single processor with multiple cores (e.g., a multi-core processor), multiple processors with a single core, multiple processors with multiples cores, or any combination thereof.

The memory 1006 includes a main memory 1016, a static memory 1018, and a storage unit 1020, both accessible to the processors 1004 via the bus 1010. The main memory 1006, the static memory 1018, and storage unit 1020 store the instructions 1002 embodying any one or more of the methodologies or functions described herein. The instructions 1002 may also reside, completely or partially, within the main memory 1016, within the static memory 1018, within machine-readable medium 1022 within the storage unit 1020, within at least one of the processors 1004 (e.g., within the processor's cache memory), or any suitable combination thereof, during execution thereof by the machine 1000.

The I/O components 1008 may include a wide variety of components to receive input, provide output, produce output, transmit information, exchange information, capture measurements, and so on. The specific I/O components 1008 that are included in a particular machine will depend on the type of machine. For example, portable machines such as mobile phones may include a touch input device or other such input mechanisms, while a headless server machine will likely not include such a touch input device. It will be appreciated that the I/O components 1008 may include many other components that are not shown in FIG. 10. In various examples, the I/O components 1008 may include user output components 1024 and user input components 1026. The user output components 1024 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1026 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1008 may include motion components 1028, environmental components 1030, or position components 1032, among a wide array of other components. The motion components 1028 can include acceleration sensor components (e.g., accelerometer), gravitation sensor components, and/or rotation sensor components (e.g., gyroscope).

The environmental components 1030 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), depth sensors (such as one or more LIDAR arrays), or other components that may provide indications, measurements, or signals corresponding to a surrounding physical environment.

With respect to cameras, the machine 1000 may have a camera system comprising, for example, front cameras on a front surface of the machine 1000 and rear cameras on a rear surface of the machine 1000. The front cameras may, for example, be used to capture still images and video of a user of the machine 1000 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the machine 1000 may also include a 360° camera for capturing 360° photographs and videos.

Further, the camera system of the machine 1000 may include dual rear cameras (e.g., a primary camera as well as a depth-sensing camera), or even triple, quad or penta rear camera configurations on the front and rear sides of the machine 1000. These multiple cameras systems may include a wide camera, an ultra-wide camera, a telephoto camera, a macro camera, and a depth sensor, for example.

The position components 1032 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1008 further include communication components 1034 operable to couple the machine 1000 to a network 1036 or devices 1038 via respective coupling or connections. For example, the communication components 1034 may include a network interface component or another suitable device to interface with the network 1036. In further examples, the communication components 1034 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1038 may be another machine or any of a wide variety of peripheral devices (e.g., a peripheral device coupled via a USB).

Moreover, the communication components 1034 may detect identifiers or include components operable to detect identifiers. For example, the communication components 1034 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1034, such as location via Internet Protocol (IP) geolocation, location via Wi-Fi® signal triangulation, location via detecting an NFC beacon signal that may indicate a particular location, and so forth.

The various memories (e.g., main memory 1016, static memory 1018, and memory of the processors 1004) and storage unit 1020 may store one or more sets of instructions and data structures (e.g., software) embodying or used by any one or more of the methodologies or functions described herein. These instructions (e.g., the instructions 1002), when executed by processors 1004, cause various operations to implement the disclosed examples.

The instructions 1002 may be transmitted or received over the network 1036, using a transmission medium, via a network interface device (e.g., a network interface component included in the communication components 1034) and using any one of several well-known transfer protocols (e.g., hypertext transfer protocol (HTTP)). Similarly, the instructions 1002 may be transmitted or received using a transmission medium via a coupling (e.g., a peer-to-peer coupling) to the devices 1038.

### Software Architecture

FIG. 11 is a block diagram 1100 illustrating a software architecture 1102, which can be installed on any one or more of the devices described herein. The software architecture 1102 is supported by hardware such as a machine 1104 that includes processors 1106, memory 1108, and I/O components 1110. In this example, the software architecture 1102 can be conceptualized as a stack of layers, where each layer provides a particular functionality. The software architecture 1102 includes layers such as an operating system 1112, libraries 1114, frameworks 1116, and applications 1118. Operationally, the applications 1118 invoke API calls 1120 through the software stack and receive messages 1122 in response to the API calls 1120. The system 100 may be implemented by components in one or more layers of the software architecture 1102.

The operating system 1112 manages hardware resources and provides common services. The operating system 1112 includes, for example, a kernel 1124, services 1126, and drivers 1128. The kernel 1124 acts as an abstraction layer between the hardware and the other software layers. For example, the kernel 1124 provides memory management, processor management (e.g., scheduling), component management, networking, and security settings, among other functionalities. The services 1126 can provide other common services for the other software layers. The drivers 1128 are responsible for controlling or interfacing with the underlying hardware. For instance, the drivers 1128 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1114 provide a common low-level infrastructure used by the applications 1118. The libraries 1114 can include system libraries 1130 (e.g., C standard library) that provide functions such as memory allocation functions, string manipulation functions, mathematic functions, and the like. In addition, the libraries 1114 can include API libraries 1132 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1114 can also include a wide variety of other libraries 1134 to provide many other APIs to the applications 1118.

The frameworks 1116 provide a common high-level infrastructure that is used by the applications 1118. For example, the frameworks 1116 provide various graphical user interface (GUI) functions, high-level resource management, and high-level location services. The frameworks 1116 can provide a broad spectrum of other APIs that can be used by the applications 1118, some of which may be specific to a particular operating system or platform.

In an example, the applications 1118 may include a home application 1136, a location application 1138, and a broad assortment of other applications such as a third-party application 1140. The applications 1118 are programs that execute functions defined in the programs. Various programming languages can be employed to create one or more of the applications 1118, structured in a variety of manners, such as object-oriented programming languages (e.g., Objective-C, Java, or C++) or procedural programming languages (e.g., C or assembly language). In a specific example, the third-party application 1140 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1140 can invoke the API calls 1120 provided by the operating system 1112 to facilitate functionalities described herein.

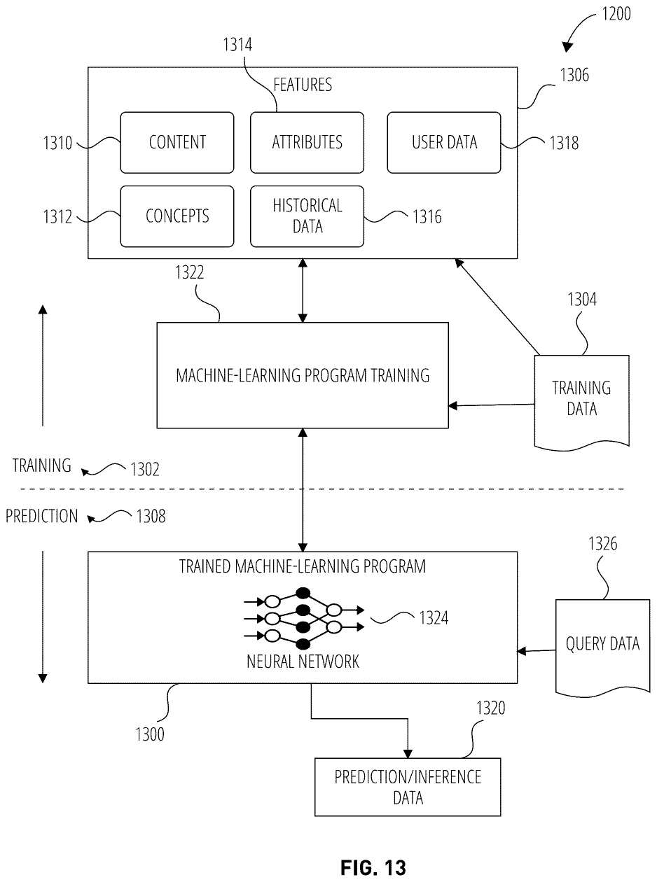

FIG. 12 is a flowchart depicting a machine-learning pipeline 1200, according to some examples. The machine-learning pipeline 1200 may be used to generate a trained model, for example the trained machine-learning program 1300 of FIG. 13, to perform operations associated with searches and query responses.

Broadly, machine learning may involve using computer algorithms to automatically learn patterns and relationships in data, potentially without the need for explicit programming. Machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

Generating a trained machine-learning program 1300 may include multiple phases that form part of the machine-learning pipeline 1200, including for example the following phases illustrated in FIG. 12:
Data collection and preprocessing 1202: This phase may include acquiring and cleaning data to ensure that it is suitable for use in the machine learning model. This phase may also include removing duplicates, handling missing values, and converting data into a suitable format.
Feature engineering 1204: This phase may include selecting and transforming the training data 1304 to create features that are useful for predicting the target variable. Feature engineering may include (1) receiving features 1306 (e.g., as structured or labeled data in supervised learning) and/or (2) identifying features 1306 (e.g., unstructured or unlabeled data for unsupervised learning) in training data 1304 (all shown in FIG. 13).
Model selection and training 1206: This phase may include selecting an appropriate machine learning algorithm and training it on the preprocessed data. This phase may further involve splitting the data into training and testing sets, using cross-validation to evaluate the model, and tuning hyperparameters to improve performance.
Model evaluation 1208: This phase may include evaluating the performance of a trained model (e.g., the trained machine-learning program 1300) on a separate testing dataset. This phase can help determine if the model is overfitting or underfitting and determine whether the model is suitable for deployment.
Prediction 1210: This phase involves using a trained model (e.g., trained machine-learning program 1300) to generate predictions on new, unseen data.
Validation, refinement or retraining 1212: This phase may include updating a model based on feedback generated from the prediction phase, such as new data or user feedback.
Deployment 1214: This phase may include integrating the trained model (e.g., the trained machine-learning program 1300) into a more extensive system or application, such as a web service, mobile app, or IoT device. This phase can involve setting up APIs, building a user interface, and ensuring that the model is scalable and can handle large volumes of data.

FIG. 13 illustrates further details of two example phases, namely a training phase 1302 (e.g., part of the model selection and trainings 1206) and a prediction phase 1308 (part of prediction 1210). Prior to the training phase 1302, feature engineering 1204 is used to identify features 1306. This may include identifying informative, discriminating, and independent features for effectively operating the trained machine-learning program 1300 in pattern recognition, classification, and regression. In some examples, the training data 1304 includes labeled data, known for pre-identified features 1306 and one or more outcomes. Each of the features 1306 may be a variable or attribute, such as an individual measurable property of a process, article, system, or phenomenon represented by a data set (e.g., the training data 1304). Features 1306 may also be of different types, such as numeric features, strings, and graphs, and may include one or more of content 1310, concepts 1312, attributes 1314, historical data 1316, and/or user data 1318, merely for example.

In training phase 1302, the machine-learning pipeline 1200 uses the training data 1304 to find correlations among the features 1306 that affect a predicted outcome or prediction/inference data 1320.

With the training data 1304 and the identified features 1306, the trained machine-learning program 1300 is trained during the training phase 1302 during machine-learning program training 1322. The machine-learning program training 1322 appraises values of the features 1306 as they correlate to the training data 1304. The result of the training is the trained machine-learning program 1300 (e.g., a trained or learned model).

Further, the training phase 1302 may involve machine learning, in which the training data 1304 is structured (e.g., labeled during preprocessing operations). The trained machine-learning program 1300 implements a neural network 1324 capable of performing, for example, classification and clustering operations. In other examples, the training phase 1302 may involve deep learning, in which the training data 1304 is unstructured, and the trained machine-learning program 1300 implements a deep neural network 1324 that can perform both feature extraction and classification/clustering operations.

In some examples, a neural network 226 may be generated during the training phase 1302, and implemented within the trained machine-learning program 1300. The neural network 1324 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 1324 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 1324 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 1302, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In prediction phase 1308, the trained machine-learning program 1300 uses the features 1306 for analyzing query data 1326 to generate inferences, outcomes, or predictions, as examples of a prediction/inference data 1320. For example, during prediction phase 1308, the trained machine-learning program 1300 generates an output. Query data 1326 is provided as an input to the trained machine-learning program 1300, and the trained machine-learning program 1300 generates the prediction/inference data 1320 as output, responsive to receipt of the query data 1326.

In some examples, the trained machine-learning program 1300 may be a generative AI model. Generative AI is a term that may refer to any type of artificial intelligence that can create new content from training data 1304. For example, generative AI can produce text, images, video, audio, code, or synthetic data similar to the original data but not identical.

Some of the techniques that may be used in generative AI are:
Convolutional Neural Networks (CNNs): CNNs may be used for image recognition and computer vision tasks. CNNs may, for example, be designed to extract features from images by using filters or kernels that scan the input image and highlight important patterns.
Recurrent Neural Networks (RNNs): RNNs may be used for processing sequential data, such as speech, text, and time series data, for example. RNNs employ feedback loops that allow them to capture temporal dependencies and remember past inputs.
Generative adversarial networks (GANs): GNNs may include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models may use attention mechanisms to learn the relationships between different parts of input data (such as words or pixels) and generate output data based on these relationships. Transformer models can handle sequential data, such as text or speech, as well as non-sequential data, such as images or code.

In generative AI examples, the output prediction/inference data 222 include predictions, translations, summaries or media content.

### Conclusion

Described examples of edge device pose-guided portrait generation can provide technical solutions to one or more technical problems.

First, implementing sophisticated image generation capabilities on edge devices like mobile phones is challenging due to limited computational resources and requirements for reasonable execution times. The described techniques can address this through implementation of a lightweight edge device model architecture with constrained parameter count optimized for edge devices, using a three-stage pipeline (preprocessing, portrait generation, and postprocessing) architecture that efficiently distributes processing, and model distillation techniques to create a compact edge device model that can run within one second on common mobile devices while maintaining generation quality.

Second, raw selfie inputs vary significantly in quality, orientation, and composition, which can negatively impact generation results. The described techniques can address this through a preprocessing pipeline that includes quality control checks (e.g., for face rotation, orientation, and color data), automated cropping to extract and normalize face regions, pose template alignment using facial landmarks, embedding generation to capture relevant facial features in a normalized format, and validation criteria during preprocessing to reject unsuitable inputs.

Third, maintaining a consistent artistic style while preserving recognizable facial features is technically challenging, especially with limited computational resources. The described techniques can address this through a training pipeline using fixed style parameters (prompts and configuration data) to ensure consistent stylistic output, and a two-phase enhancement approach that first generates a stylized portrait and then enhances the fidelity of the face or head. Training the model using large datasets (e.g., 25,000-100,000 pairs) of corresponding inputs and style-consistent targets improves stylistic consistency. Finally, the example provide the option to deploy multiple lightweight models, each trained for a specific style, thereby improving stylistic consistency through specialization by individual models.

Fourth, creating effective training datasets for edge device models while maintaining quality and consistency is complex and resource-intensive. The described techniques can address this through an automated training data generation pipeline using mixed dataset of synthetic and real-world facial images, consistent preprocessing steps matching those of the inference pipeline, fixed prompts and configuration for stylistic consistency, and a distillation training approach that uses larger pretrained models to generate high-quality training targets, establishes relationships between preprocessed inputs and styled outputs, and employs multiple loss types (e.g., L1/L2, perceptual, discriminator-based) for optimization.

Fifth, different edge devices have varying capabilities and resource constraints, requiring flexible processing distribution. The described techniques can address this through a modular architecture allowing core portrait generation on the edge device, optional on-device or backend enhancement processing, flexible pose template management, and multiple deployment options, including individual style-specific apps for app store distribution, backend API integration for enhanced processing, and a network architecture supporting distributed processing.

### Examples

In view of the disclosure above, various examples are set forth below. It should be noted that one or more features of an example, taken in isolation or combination, should be considered within the disclosure of this application.

Example 1 is a system comprising: at least one processor; and at least one memory storing instructions that, when executed by the at least one processor, configure the system to perform operations comprising: obtaining an input image comprising a view of a face; preprocessing the input image to generate a pose and face image comprising the view of the face and a visual representation of at least a portion of a body pose; and on an edge device of the system comprising an edge device processor of the at least one processor and an edge device memory of the at least one memory, applying an edge device model to the pose and face image to generate a portrait having a portrait style and comprising at least a portion of a body posed according to the body pose and a stylized depiction of the face, the edge device model being trained to establish a relationship between a plurality of training inputs comprising pose and face images and corresponding training targets comprising portraits having the portrait style.

In Example 2, the subject matter of Example 1 includes, wherein: the edge device comprises a mobile device.

In Example 3, the subject matter of Example 2 includes, wherein: obtaining the input image comprises capturing a self-portrait photograph via at least one optical sensor of the mobile device.

In Example 4, the subject matter of Examples 1-3 includes, wherein: the preprocessing is performed on the edge device.

In Example 5, the subject matter of Examples 1-4 includes, wherein: the preprocessing further comprises cropping the input image to generate a cropped image comprising the view of the face.

In Example 6, the subject matter of Examples 1-5 includes, wherein: the preprocessing further comprises generating embeddings based on the input image; and the edge device model is applied to the pose and face image and the embeddings to generate the portrait.

In Example 7, the subject matter of Examples 1-6 includes, wherein: the operation further comprise postprocessing the portrait to enhance a correspondence between the view of the face in the input image and the stylized depiction of the face in the portrait.

In Example 8, the subject matter of Example 7 includes, wherein: the input image comprises a view of a head comprising the view of the face; the portrait comprises a stylized depiction of the head; and the postprocessing of the portrait further comprises enhancing a correspondence between the view of the head in the input image and the stylized depiction of the head in the portrait.

In Example 9, the subject matter of Examples 7-8 includes, wherein: the postprocessing of the portrait is performed on the edge device.

In Example 10, the subject matter of Examples 7-9 includes, wherein: the postprocessing of the portrait is performed at least in part by components of the system separate from the edge device.

In Example 11, the subject matter of Examples 1-10 includes, wherein: the training targets are generated by a pretrained image generation model based on input data corresponding to the portrait style, the input data comprising at least one of prompt data or configuration data.

In Example 12, the subject matter of Example 11 includes, wherein: the training inputs are generated by preprocessing input images.

In Example 13, the subject matter of Example 12 includes, wherein: the input images used to generate the training inputs comprise synthetic images of faces.

In Example 14, the subject matter of Examples 12-13 includes, wherein: the preprocessing of the input images used to generate the training inputs comprises discarding input images based on one or more of the following criteria: improper rotation of the face in the input image, improper view of the face in the input image, or improper color data of the input image.

Example 15 is a method comprising: obtaining an input image comprising a view of a face; preprocessing the input image to generate a pose and face image comprising the view of the face and a visual representation of at least a portion of a body pose; and on an edge device, applying an edge device model to the pose and face image to generate a portrait having a portrait style and comprising at least a portion of a body posed according to the body pose and a stylized depiction of the face, the edge device model being trained to establish a relationship between a plurality of training inputs comprising pose and face images and corresponding training targets comprising portraits having the portrait style.

In Example 16, the subject matter of Example 15 includes, wherein: the edge device comprises a mobile device.

In Example 17, the subject matter of Example 16 includes, wherein: obtaining the input image comprises capturing a self-portrait photograph via at least one optical sensor of the mobile device.

In Example 18, the subject matter of Examples 15-17 includes, training the edge device model by: generating the training targets by a pretrained image generation model based on input data corresponding to the portrait style, the input data comprising at least one of prompt data or configuration data; generating the training inputs by preprocessing input images; and training the edge device model to establish the relationship between the training targets and the training inputs.

In Example 19, the subject matter of Example 18 includes, wherein: the preprocessing of the input images used to generate the training inputs comprises discarding input images based on one or more of the following criteria: improper rotation of the face in the input image, improper view of the face in the input image, or improper color data of the input image.

Example 20 is a non-transitory computer-readable storage medium, the computer-readable storage medium including instructions that when executed by at least one processor of a system, cause the system to perform operations comprising: obtaining an input image comprising a view of a face; preprocessing the input image to generate a pose and face image comprising the view of the face and a visual representation of at least a portion of a body pose; and on an edge device of the system, applying an edge device model to the pose and face image to generate a portrait having a portrait style and comprising at least a portion of a body posed according to the body pose and a stylized depiction of the face, the edge device model being trained to establish a relationship between a plurality of training inputs comprising pose and face images and corresponding training targets comprising portraits having the portrait style.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Other technical features may be readily apparent to one skilled in the art from the following figures, descriptions, and claims.

### GLOSSARY

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

A “communications network” refers to, for example, one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Edge device” refers to, for example, a client device, user device, or mobile device intended for direct physical use by a human user. Edge devices include but are not limited to devices that operate at the boundary of a network, typically interfacing directly with the physical environment (including the human user) or other networks. An edge device is typically characterized by having limited computing resources relative to computing systems accessible via a communication network.

“Machine storage medium” refers, for example, to a single or multiple storage devices and/or media (e.g., a centralized or distributed database, and/or associated caches and servers) that store executable instructions, routines and/or data. The term shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Mobile device” refers, for example, to any machine that is portable by a human user and intended to be used while away from a fixed workstation. A mobile device may be, but is not limited to, a mobile phone, a tablet computer, or a wearable computing device.

“Network” may include, for example, one or more portions of a network that may be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VoIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable storage medium” refers, for example, to a tangible medium that is capable of storing, encoding, or carrying the instructions for execution by a machine.

“Processor” refers, for example, to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action, or an interaction with other users or computer systems.

What is claimed is:

1. A system comprising:
at least one processor; and
at least one memory storing instructions that, when executed by the at least one processor, configure the system to perform operations comprising:
obtaining an input image comprising a view of a face;
preprocessing the input image to generate a pose and face image comprising the view of the face and a visual representation of at least a portion of a body pose; and
on an edge device of the system comprising an edge device processor of the at least one processor and an edge device memory of the at least one memory, applying an edge device model to the pose and face image to generate a portrait having a portrait style and comprising at least a portion of a body posed according to the body pose and a stylized depiction of the face,
the edge device model being trained to establish a relationship between a plurality of training inputs comprising pose and face images and corresponding training targets comprising portraits having the portrait style.

2. The system of claim 1, wherein:
the edge device comprises a mobile device.

3. The system of claim 2, wherein:
obtaining the input image comprises capturing a self-portrait photograph via at least one optical sensor of the mobile device.

4. The system of claim 1, wherein:
the preprocessing is performed on the edge device.

5. The system of claim 1, wherein:
the preprocessing further comprises cropping the input image to generate a cropped image comprising the view of the face.

6. The system of claim 1, wherein:
the preprocessing further comprises generating embeddings based on the input image; and
the edge device model is applied to the pose and face image and the embeddings to generate the portrait.

7. The system of claim 1, wherein:
the operations further comprise postprocessing the portrait to enhance a correspondence between the view of the face in the input image and the stylized depiction of the face in the portrait.

8. The system of claim 7, wherein:
the input image comprises a view of a head comprising the view of the face;
the portrait comprises a stylized depiction of the head; and
the postprocessing of the portrait further comprises enhancing a correspondence between the view of the head in the input image and the stylized depiction of the head in the portrait.

9. The system of claim 7, wherein:
the postprocessing of the portrait is performed on the edge device.

10. The system of claim 7, wherein:
the postprocessing of the portrait is performed at least in part by components of the system separate from the edge device.

11. The system of claim 1, wherein:
the training targets are generated by a pretrained image generation model based on input data corresponding to the portrait style, the input data comprising at least one of prompt data or configuration data.

12. The system of claim 11, wherein:
the training inputs are generated by preprocessing input images.

13. The system of claim 12, wherein:
the input images used to generate the training inputs comprise synthetic images of faces.

14. The system of claim 12, wherein:
the preprocessing of the input images used to generate the training inputs comprises discarding input images based on one or more of: improper rotation of the face in the input image, improper view of the face in the input image, or improper color data of the input image.

15. A method comprising:
obtaining an input image comprising a view of a face;
preprocessing the input image to generate a pose and face image comprising the view of the face and a visual representation of at least a portion of a body pose; and
on an edge device, applying an edge device model to the pose and face image to generate a portrait having a portrait style and comprising at least a portion of a body posed according to the body pose and a stylized depiction of the face,
the edge device model being trained to establish a relationship between a plurality of training inputs comprising pose and face images and corresponding training targets comprising portraits having the portrait style.

16. The method of claim 15, wherein:
the edge device comprises a mobile device.

17. The method of claim 16, wherein:
obtaining the input image comprises capturing a self-portrait photograph via at least one optical sensor of the mobile device.

18. The method of claim 15, further comprising:
training the edge device model by:
generating the training targets by a pretrained image generation model based on input data corresponding to the portrait style, the input data comprising at least one of prompt data or configuration data;
generating the training inputs by preprocessing input images; and
training the edge device model to establish the relationship between the training targets and the training inputs.

19. The method of claim 18, wherein:
the preprocessing of the input images used to generate the training inputs comprises discarding input images based on one or more of: improper rotation of the face in the input image, improper view of the face in the input image, or improper color data of the input image.

20. A non-transitory computer-readable storage medium, the computer-readable storage medium including instructions that when executed by at least one processor of a system, cause the system to perform operations comprising:
obtaining an input image comprising a view of a face;
preprocessing the input image to generate a pose and face image comprising the view of the face and a visual representation of at least a portion of a body pose; and
on an edge device of the system, applying an edge device model to the pose and face image to generate a portrait having a portrait style and comprising at least a portion of a body posed according to the body pose and a stylized depiction of the face,
the edge device model being trained to establish a relationship between a plurality of training inputs comprising pose and face images and corresponding training targets comprising portraits having the portrait style.
